(19) United States
(12) Patent Application Publication
(10) Pub. No.: US 2025/0355778 A1
(43) Pub. Date: Nov. 20, 2025

(54) Extensible Framework For Database Testing With Random Query Generation

(71) Applicant: Google LLC, Moutntain View, CA (US)

(72) Inventors: Xiaobin Ma, Fremont, CA (US); Haoyu Huang, Fremont, CA (US); Jordan Lozinski, Chicago, IL (US); Akhil Mehendale, San Jose, CA (US)

(21) Appl. No.: 18/663,798

(22) Filed: May 14, 2024

(51) Int. Cl. G06F 11/34; G06F 11/36; G06F 16/21

(52) U.S. Cl. CPC G06F 11/3409; G06F 11/3688; G06F 16/211

(57) ABSTRACT

Methods, systems, and apparatus, including computer-readable storage media for testing features of a database management system (DBMS). A DBMS testing framework generates new random test cases for testing database features on the system. The framework receives a query grammar specifying the structure of queries to generate and generates the queries randomly. The framework executes the queries with database features randomly enabled or disabled and generates performance data from the results of executing those queries. The framework identifies points of failure in the performance data, corresponding to instances in which queries executed with certain combinations of database features result in incorrect output, or degraded performance relative to executing the queries without the database features enabled. The testing framework divides the database preparation, query generation, and query execution parts of a test pipeline into separate components, which can be modified separately or left to proceed in a default operating mode.

### BACKGROUND

A database management system (DBMS) is a computing system for storing, querying, retrieving, or processing data stored in databases. A DBMS can be implemented with a variety of different features, for example, to automate certain tasks like database backup, replication, capacity management, etc. As new features are implemented, different tests should be performed to test that the features operate accurately and without introducing bugs or other issues for other features of the DBMS, or in general. For example, a correctness test can be performed to make sure a new feature generates the correct result or output. As another example, a performance test can be performed to check that the DBMS is meeting predefined latency or performance requirements when executing the feature. As yet another example, a stress test can be performed to test how well the DBMS handles scaling the execution of the feature, such as when limited computing resources are available or demand for the feature spikes or increases over time.

### BRIEF SUMMARY

Aspects of the disclosure are directed to a method of testing database features through an extensible database management system (DBMS) testing framework. The DBMS testing framework is an example of a system configured to generate specific new random test cases for testing database features on the system. A random query generator of the DBMS testing framework receives a query grammar specifying the structure of queries to generate and generates queries randomly. The DBMS executes the queries with database features randomly enabled or disabled and generates performance data from the results of executing those queries.

A test driver of the DBMS testing framework identifies points of failure in the performance data, corresponding to instances in which queries executed with certain combinations of database features result in incorrect output or degraded performance relative to executing the queries without the database features enabled. The test driver can control interaction between the DBMS testing framework and user input, as well as modify parts of a test pipeline, start database instances, start testing, and analyze results as described herein. To that end, components of the DBMS testing framework can be modified by the test driver to change how the testing framework tests various database features. The DBMS testing framework divides the database preparation, query generation, and query execution parts of a test pipeline into separate components. Each individual component of the pipeline can be modified by the test driver provided to the DBMS or left to proceed in a default operating mode.

Other implementations of this aspect include corresponding computer systems, apparatus, and computer programs recorded on one or more computer storage or memory devices, each configured to perform the actions or operations of the methods.

### BRIEF DESCRIPTION OF THE DRAWINGS

FIG. 1 is a block diagram of an example database management system within a database management system testing framework, according to aspects of the disclosure.

FIG. 2 is a block diagram of an example query derivation, according to aspects of the disclosure.

FIG. 3 is a flow diagram of an example process for database feature testing with a database management system, according to aspects of the disclosure.

FIG. 4 is a flow diagram of an example process for database feature testing with a database management system and a test driver, according to aspects of the disclosure.

FIG. 5 is a block diagram of an example computing environment for implementing the system.

### DETAILED DESCRIPTION

### Overview

Aspects of the disclosure are directed to a method of testing database features through an extensible database management system (DBMS) testing framework. The DBMS testing framework can generate specific new random test cases for testing database features on the system. As described herein, the DBMS testing framework can implement various components for generating random test cases, executing queries, generating performance data, and performing and verifying tests. Each component is configured to be modified by a test driver, for example to change how the DBMS testing framework generates the random queries, executes those queries, and/or verifies the queries against tests specified in the test driver. The DBMS testing framework receives a query grammar specifying the structure of queries and generates queries randomly. A DBMS of the DBMS testing framework executes the queries with database features randomly enabled or disabled and generates performance data from the results of executing those queries.

Extensibility means that new test cases, test features, testing tools, and testing targets can be added to the framework. For example, the framework can receive new test grammars to add and be used to randomly generate new types of SQL queries to test new database features. Other tools can be incorporated into the framework to test a specific target database system feature, implemented as test drivers received by the testing framework.

By generating new queries in accordance with a received query grammar and executing the queries with randomly enabled and disabled database features, the DBMS or another component of the DBMS testing framework can generate performance data that can be used to better identify points or sources of failure caused by bugs in tested database features, as compared with approaches preconfigured to handle only a subset of possible tests, or approaches that rely on a predetermined list of queries to execute. The performance data can correspond to a wider range of database features, test cases, or test targets at least because the DBMS is not confined to a specific format or structure of query during testing. As a result, database features can be tested and deployed more accurately and with fewer issues, leading to less downtime and errors on the DBMS.

Generating queries randomly according to a received query grammar can limit the search space of possible queries to queries formatted in accordance with the query grammar, reducing the chance of queries being generated that do not test a target database feature. The specificity allowed by a grammar-based approach to query generation can allow for certain types of behavior in a database feature to be targeted better as compared to other approaches to target feature behavior, such as hand-written lists of test cases. A random query generator of the DBMS testing framework can generate a larger number of queries consistent with a query grammar, to canvas a space of potential input for testing, without requiring that all queries be known ahead of time.

The DBMS can execute, at random, the generated queries with and without different database features enabled. Different combinations of database features running together may result in different interactions or behaviors on the DBMS during query execution. A random selection of enabled and disabled database features can uncover potential corner cases or combinations that result in incorrect query output, and/or degradation in system performance, in a manner that is more consistent over writing test cases based on predicted trouble areas.

The DBMS can identify points of failure and sources of failure using generated performance data. The DBMS testing framework can compare performance data between executions of queries with a tested database feature enabled with executions of queries with the tested database feature disabled. The DBMS testing framework can compare differences between data characterizing query executions according to different criteria or thresholds. The DBMS testing framework can receive and execute a test driver for providing these criteria or thresholds. The test driver can be configured to perform the comparison or other analyses, which may vary, for example, based on the specific testing needs for a user. By comparing instances of performance data between executions of queries with and without a tested database feature enabled, the DBMS testing framework can test for correctness, performance, and/or stress on the system overall, during query execution. The type of test or the thresholds or criteria can vary from example to example, as the DBMS testing framework is configured to adjust how the performance data is processed, e.g., through a received or predetermined test driver. The DBMS testing framework can adjust how the performance data is processed to account for different types of tests.

Further, because the performance data can be generated in a way as to canvas a portion of a possible input space targeted by a query grammar with random feature execution, the DBMS testing framework is not limited to performing only predetermined types of query verifications or tests. This is at least because components of the DBMS testing framework described as performing these query verifications or tests can be replaced or modified by a test driver received by the framework. The depth and breadth of the possible input space captured by the performance data allows for different tests to be performed. The different tests may be of varying levels of specificity or coverage.

The broad testing range on specially tailored spaces of query input can improve concurrency testing for a given database feature, at least because the range of possible generated queries can be executed automatically on different threads or processes of execution. The execution of different permutations of enabled and disabled database features over multiple threads or processes can improve the detection of corner cases or feature issues that may only occasionally appear when parallel processing multiple queries. With hand-crafted or other collections of queries that do not rely on a grammar-based approach and random execution, these issues are more likely to be missed, resulting in less robust performance data, and subsequently, worse analysis for identifying root causes and places where a database feature can be optimized.

The DBMS testing framework can identify sources of failure, which can include database features or combinations of database features that either cause the DBMS to execute queries inaccurately or cause the performance of the DBMS to degrade relative to when queries are executed without the tested database features enabled. For example, the DBMS testing framework can process the performance data to determine which database features were enabled when errors or performance degradation occurred.

Identification of the points or sources of failures can be modified by a test driver received by the DBMS testing framework, to allow the testing framework to be extended to identify failures to different database features and/or under different types of tests, such as correctness tests, performance tests, scaling tests, and so on. Based on this determination, the DBMS testing framework can output a list of database features with potential bugs or undesired behavior. Software modules or other components in communication with the DBMS or other components implementing the listed database features can be identified for further review, either manually or automatically through a downstream process, such as a source code analysis program or a debugging environment. In some examples, the DBMS testing framework can also provide a dump of contents of a cache or a database at the points of failure, as additional data for analysis or for providing to a debugging environment for further testing.

The DBMS testing framework can facilitate the execution of queries in accordance with various test parameters. The DBMS testing framework divides the database preparation, query generation, and query execution parts of a testing pipeline into separate components. Each individual component of the pipeline can be modified by a test driver provided to the DBMS testing framework or left to proceed in a default operating mode. The default operating mode can be as described above, in which the DBMS testing framework receives a query grammar, prepares a database in accordance with a received schema, generates queries randomly in accordance with the query grammar, and executes the queries with different flagged database features enabled and disabled at random. The default operating mode can also include the DBMS testing framework receiving a database schema specifying the format of data in a database, spinning up an instance of a database structured in accordance with the schema, and further generating and executing queries targeting data in accordance with the database schema. A test driver can provide different example configurations to modify what types of grammars are received, how queries are generated in accordance with the query grammar, and how queries are executed by the DBMS with different flagged database features enabled or disabled.

According to aspects of the disclosure, a testing framework can further implement an interface for receiving a test driver, which can be a software application or a set of instructions, that can replace or modify some or all of the different parts of the testing framework described above.

The test driver of the testing framework represents the control logic for modifying some or all parts of the test pipeline, receiving user input, starting database instances for testing, starting testing, and analyzing results. The DBMS testing framework 300 may operate in accordance with a predetermined or default test driver, or receive a test driver, e.g., as user input. Each component of the DBMS testing framework can receive input from executing the test driver to modify some or all of the operations the component is configured to perform. For example, a test driver can be received for modifying how data is prepared in databases for testing, what types of testing is done, and how results from executing the queries are analyzed. Components or operations not modified by the test driver may operate according to a default behavior.

The interface for receiving the test driver can be over a webpage, a desktop application, API, etc. The test driver can be received as user input. The testing framework checks to see whether the test driver is configured to generate performance data within a predetermined format, which the DBMS can receive for identifying points of failure or inefficiencies of the tested features. The DBMS testing framework can also check for certain function calls, classes, or logical demarcations in a received test driver corresponding to what parts of the framework to modify or remove.

### Example Systems

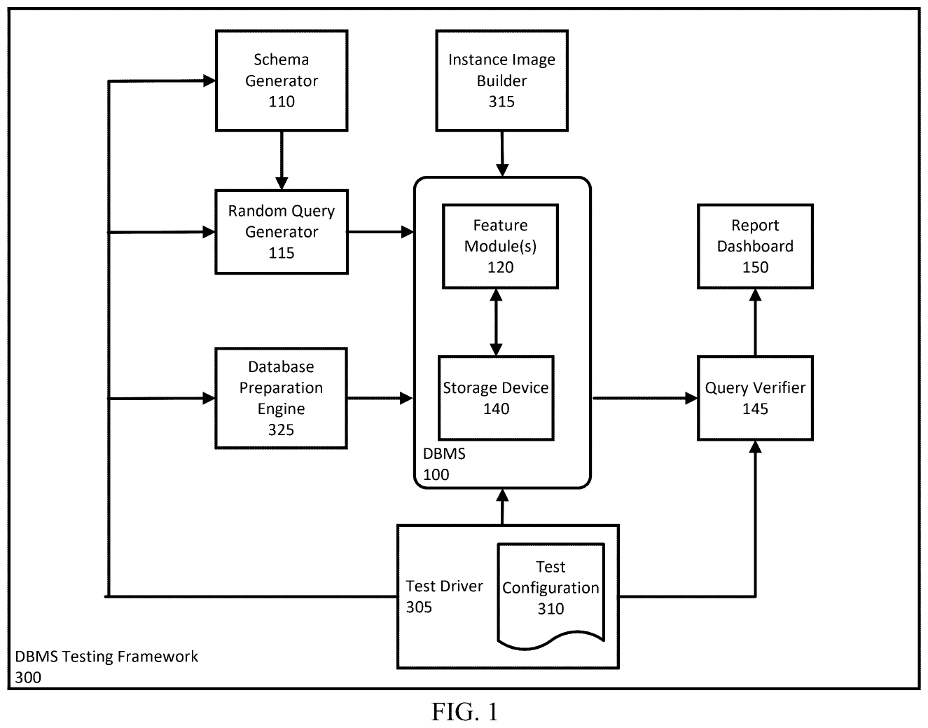

FIG. 1 is a block diagram of an example database management system (DBMS) 100 within a DBMS testing framework 300, according to aspects of the disclosure. The DBMS testing framework 300 can include different components, modules, or engines implemented in a combination of software or hardware. It is understood, however, that various examples of the DBMS testing framework 300 can include different combinations of the depicted components or other components. The operations described by the testing framework 300 and/or the DBMS 100 within the framework 300 may be split across multiple sub-components or combined into a larger component.

For example, the testing framework 300 includes a schema generator 110, a random query generator 115, a database preparation engine 325, an instance image builder 315, a query verifier 140, and a report dashboard 150. The DBMS 100 can include one or more storage devices, such as storage device 140, and one or more feature module(s) 120. The framework 300 can also be implemented as a combination of hardware and software, and although shown separate from the DBMS 100, may be executed on the same device, one or more different devices, or a combination thereof.

The schema generator 110 is configured to generate database schemas for databases stored in the storage device 140. Database schemas can at least partially define how data is organized or represented in a query or in a database. Schemas generated by the schema generator 110 can be fed into databases stored on the storage device 140 for organizing data according to the schemes, and/or the random query generator 115 for generating queries targeting tables or portions of data in the databases stored in the storage device 140 in accordance with the schemas.

A database can refer to any collection of data, as well as devices implementing the database, such as storage device 140 and one or more processors. The data can be unstructured or structured in any manner. The data can be stored on one or more storage devices in one or more locations. For example, an index database can include multiple collections of data, each of which may be organized and accessed differently.

Storage device 140 can store one or more databases and/or additional data, such as database images, previous or currently generated queries by the random query generator 115, performance data, and/or content dumps of databases taken at different timestamps. The data stored in the storage device 140 can be provided as part of providing performance data and/or analyses performed by the DBMS testing framework 300, e.g., by test driver 305, described in more detail herein.

DBMS testing framework 300 includes a random query generator 115 configured to generate structured queries based on a given database scheme and a query grammar. A query grammar describes how queries are formatted or structured. The query grammar can be provided, for example, as a set of rules, with start symbols, end symbols, terminal symbols, and non-terminal symbols. The query grammar can be provided as a tree with edges and nodes, where the nodes can represent the start and end of an expression, as well as terminal or non-terminal symbols defined in the grammar. For example, the query grammar received by the generator 115 can be a context-free grammar, although in various examples different types of grammars can be provided. The grammar can be presented according to Backus-Naur form (BNF) or any other grammar format or structure.

Example query grammars can include query grammars for defining portions of SQL or custom implementations of SQL. Custom implementations can include grammars defining extended SQL grammars, with custom elements that are included into the grammar rules and subsequently in queries generated by the generator 115. For example, the query generator 115 can receive the query grammar rule:
query::=SELECT selectExpr FROM fromExpr whereExpr

The example query grammar rule defines a type of select statement, where target data (selectExpr) is selected from a target source (fromExpr) in accordance with a condition or parameter (whereExpr). Although a select statement is shown, other example types of rules are possible, for example, to cause the generator 115 to generate query statements for inserting, deleting, or updating databases in accordance with generated statements.

Test driver 305 can be a software engine configured to modify any or all operations described herein with reference to the various other components of the DBMS testing framework 300, including, for example, the query verifier 145, the random query generator 115, the query verifier 145. The test driver 305 can be a software application that receives test configurations and modifies or prepares test pipeline, prepares or configures the database, and/or determines the verifier mode, for example, whether verifier 145 does correctness or performance analysis.

For example, the test driver 305 can be configured to receive the query grammar, for example as user input, or have the query grammar predetermined. The random query generator 115 is configured to accept input, for example generated by the test driver 305, to modify how the query grammar is parsed or used to generate the random queries. For instance, the test driver 305 can control how many queries are generated, what types of behavior to have represented in the queries, e.g., queries for adding, removing, selecting, or updating data, and so on.

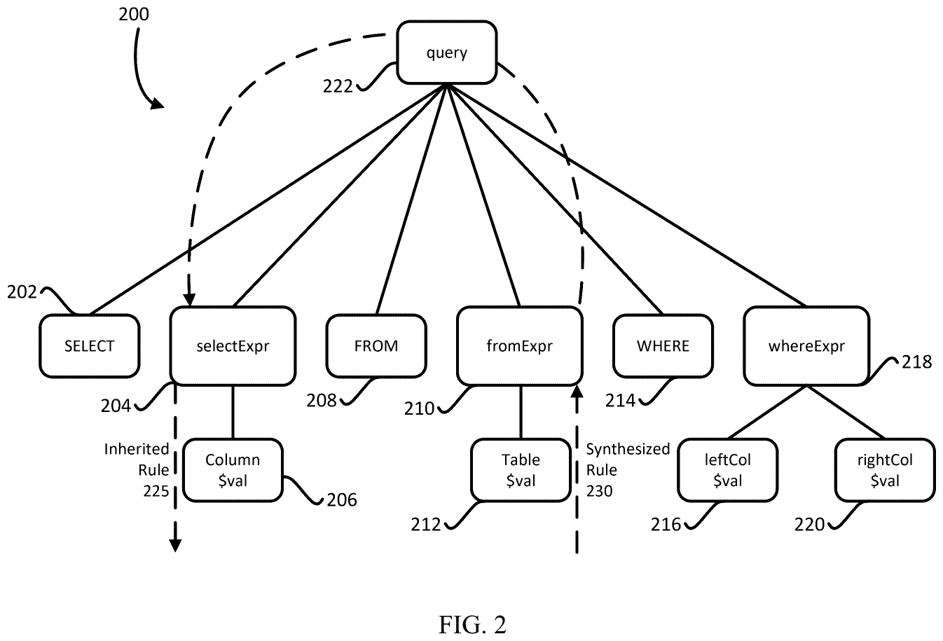

FIG. 2 is a block diagram of an example query derivation 200, according to aspects of the disclosure. The generator 115 can generate an ordered parse tree with nodes corresponding to parts of a candidate query consistent with a received query grammar. The derivation 200 shows one of possibly multiple levels of query execution. For example, the query generator 115 may generate nested query statements from a grammar defining multiple levels of expressions, sub-expressions, and/or other information that may be represented in a query, consistent with the grammar. Inherited rules represent data from an upper level of the query to a lower level of the query. Query node 222 can represent upper levels of the nested query. Expressions evaluated from those upper levels are referred to as an inherited rule 225, of which there may be multiple. Similarly, a synthesized rule 230 can represent expressions evaluated at lower levels of a nested query statement. Synthesized rules represent data passed from a lower level of the query to an upper level of the query. Upper and lower levels, if present, can be represented by additional nodes in the parse tree, but are not shown in FIG. 2 for purposes of clarity.

Select node 202 can represent a SELECT operation defined in a query, although in various examples other types of nodes can be used, to represent update query operations, adding data operations, deleting data operations, and so on. Other keyword nodes include nodes 204 and 214, for representing keywords FROM and WHERE, respectively.

The generator 110 can select a random table according to table $val node 212 for selecting a target table from a database stored in the storage device 140. The generator 115 can apply a synthesized rule 230 to pull table information up to the query node 222 and uses an inherited rule 225 to push table information from the query node to the selectExpr node 204. The synthesized rule 230 may be a rule derived from evaluating the fromExpr node 210 and any sub-nodes including additional expressions. The generator 110 can use the inherited rule 225 to randomly select columns, represented as column $val node 206. The inherited rule 225 may define limitations or conditions on the select expression, represented by the selectExpr node 204.

WHERE node 214 defines the WHERE keyword, in the context of a SQL-based grammar. whereExpr node 218 represents a condition for selecting data. leftCol $val 216 and rightCol $val 220 can represent operands or values defining a logical condition that selected data must satisfy when the query is executed. The generator 115 can perform repeated executions of the derivation 200 to randomly populate values of a select query statement and generate multiple queries in accordance with a received query grammar.

Generating queries in accordance with a received grammar limits the input space of various DBMS tests to a relevant space defined by the query grammar. At the same time, the limitation of the input space also allows for more focused tests, at least because more examples from the input space can be selected for testing, as opposed to query generation across multiple, potentially irrelevant, query formats. To that end, more specific tests can be performed by specific query grammars, at least because the computational effort in randomly generating the queries can be focused on queries that are targeted for testing. Corner cases and edge conditions can be identified more readily by generating queries from grammars that are more likely to invoke those cases or edge conditions.

Returning to FIG. 1, after generating the random queries, the DBMS 100 can execute the queries. Query verifier 145 is configured to record log data characterizing different aspects of the query execution, e.g., query execution accuracy, latency, computing resource usage, and so on. For example, the verifier 145 can record the processing state of devices forming the DBMS 100 at the time of query execution, including memory bandwidth usage, network latency, and time between receiving the query and responding to the query with an output. In some examples, test driver 305 can cause the query verifier 145 to modify what sorts of data is logged, for example by providing input to the query verifier 145. The query verifier 145 is configured to receive input from the test driver 305, and generate log data in accordance with the input, which may specify what types of data to log, and/or how detailed the log should be.

Feature module(s) 120 implemented in the DBMS 100 are modules implementing different DBMS features, which may be the target of testing. Database features can be any type of process or optimization performed on a database management system, ranging from new utilities or functionalities to optimization techniques for different processes related to managing and querying databases.

Example database features include features for a columnar engine or columnar cache, aggregation optimization techniques, query execution optimization techniques, and new database schemas. Other example database features can include applications or processes performed by the DBMS 100 on stored data, such as AI model execution or training, data analytics, or generally any type of processing pipeline for data stored in databases managed by the system and stored in memory or storage devices. Yet other example database features include test dictionaries or other data structures, raw and minimum/maximum columnar engine formats, and so on. Other example database features include, vectorized aggregation and columnar engine JSON. Feature modules 120 implement one or more different database features and may be configured to be enabled or disabled during execution of queries by the DBMS testing framework 300. Some feature modules may be enabled only during testing, for example because the modules are not fully tested for production.

The DBMS 100 is configured to execute the generated queries and store the results and metadata associated with the performance or execution of the queries. The DBMS 100 randomly determines which database features are enabled or disabled during execution of different queries. For example, the same or different queries can be executed, with different combinations of database features enabled or disabled. The framework 300 can receive test drivers for defining which features are enabled or disabled during query execution, in addition to other possible modifications to how the DBMS 100 generates data, generates queries, and/or executes queries.

To determine which database features to enable during query execution to target a database feature for testing, the DBMS 100 can receive control data indicating which database features to test. The control data may be, for example, in the form of control flags, which the DBMS 100 can receive and enable or disable features in accordance with the flags. The DBMS 100 can execute queries with and without the flagged database features enabled, as well as optionally one or more other database features, to generate performance data characterizing the performance of the system for different feature combinations. In some examples, control data is provided as part of the test driver 305. In some examples, control data is received without a test driver 305, and the DBMS testing framework 300 can operate according to a predetermined default set of operations for generating queries, executing queries, testing queries, analyzing the query results, and so on.

Query generation and query execution can proceed for a predetermined number of iterations or for a predetermined period of time. The DBMS 100 can include predetermined parameters for determining, for example, how many queries to generate or execute, and when to stop. A stop or pausing condition can be based on the results of the query execution or provided as user input. In some examples, the DBMS 100 can retrieve pre-generated queries, for example, stored in the storage device 140, and re-execute the queries across multiple batches of query execution.

Performance data can include correctness data characterizing the correctness of output from executing the queries, with and without tested database features enabled. The test driver 305 can process the performance data to determine which database features were enabled or disabled, resulting in different results for the same queries executed. The test driver 305 may, additionally or alternatively, determine which query executions result in incorrect output, using ground-truth outputs as a reference. The ground-truth outputs may be predetermined, provided in advance, or based on the outputs of query executions without database features enabled. The query verifier 145 can be configured to determine which queries fail various tests, with the tests and conditions for failing the tests provided as part of the test driver 305.

Performance data can also include performance data characterizing the performance of the DBMS 100 when executing different queries with tested database features enabled. For example, the DBMS 100 can track system configuration at the time of a query execution, as well as utilization of different computing resources. For example, the DBMS 100 can track memory utilization, memory bandwidth utilization, processor utilization, query execution latency, etc., related to measuring the performance of the DBMS 100 when queries are executed with and without the tested database feature enabled. The DBMS 100 can process the performance data to identify differences in resource utilization or performance between queries executed with a database feature enabled, with queries executed without the database feature enabled. During or after query execution, the DBMS 100 can store performance data related to the execution of the randomly generated queries. In some examples, a different component of the DBMS testing framework 300 can perform some or all of the performance data generation and/or tracking.

The query verifier 145 receives the performance data and identifies, based on the performance data, one or more points of failure indicated in the performance data. A point of failure can be one or more indications that a query failed to meet conditions for a test. For example, the performance data can indicate that a test failed for not providing a correct query result, the query was not executed at all, or performance characteristics surrounding the execution of the query, e.g., latency, memory usage, processing clock cycle count, and so on, did not satisfy one or more predetermined test conditions. The verifier 145 can further identify one or more modules as sources for these points of failure. The identified modules may be feature modules 120 that were enabled when an executed query failed a test.

The query verifier 145 can report diagnostic information, such as enabled database features and other conditions of the DBMS 100 at the time of query execution. The verifier 145 can report the contents of caches, e.g., database or columnar caches, as a content dump or snapshot at the time of the testing failures. The diagnostic information can be reported, for example through a report dashboard 150, and/or provided to one or more other devices, systems, and/or frameworks for further testing, analysis, or debugging. For example, the verifier 145 can provide diagnostic information to a debugging environment for more detailed analysis of the source of the error. Information such as test description and configurations, test output links, performance data, and test status etc., can be presented on the test report dashboard 150.

The verifier 145 narrows the ultimate root cause of an issue or bug through a provided list of enabled modules during query execution. In some examples, the query verifier 145 compares performance data from related or identical queries with different combinations of database features enabled. The query verifier 145 can provide the differences as a list of candidate sources of failure for observed failed tests.

The verifier 145 can narrow the list of candidate sources of failure, for example by re-executing queries in which points of failure occurred, with subsets of listed features enabled. The verifier 145 can, by process of elimination, identify a smaller list of candidate sources of failure, for example, by including feature modules 120 that were enabled in all instances of query failure.

The verifier 145 can also compare performance results of identical or similar queries, e.g., created using the same query grammar, to identify points of failure. For example, the verifier 145 can compare the performance of a query execution with certain database features enabled versus the performance of the query execution with the database features disabled. If the difference in performance, e.g., latency, memory usage, etc., meets or exceeds a predetermined threshold, the verifier 145 can flag the database features as potential points of failure.

The test driver 305 can provide input to the verifier 145 for determining how the verifier 145 performs query verification, e.g., including what tests to perform, how to compare results between queries, and so on. The query verifier 145 can be configured to operate in a default manner, e.g., with default tests on the query results, in examples in which the test driver 305 does not modify the query verifier 145. The query verifier 145 is configured to receive input from the test driver 305 for modifying how it performs query verification. In some examples, operations for query verification may be performed entirely or partly by the test driver 305.

The DBMS 100 can execute queries along multiple threads of execution. For example, different threads can be used to execute different types of queries. Multiple threads can be used to execute select, insert, delete, and update queries. Performance data can include performance data executing in parallel or concurrently along different threads of execution. To that end, the verifier 145 can analyze and compare performance results across different threads of execution and identify points of failure that may only sporadically occur when queries are executed in a concurrent fashion with some database features enabled.

A grammar-based approach to generating queries allows for targeting specific types of queries or specific aspects of a database feature for testing. In combination with a random execution of different test database features, the DBMS 100 can generate performance data that is specific to the testing needs at least partially represented by the query grammar and control data, while still covering the range of possible inputs and interactions with other database features that a database feature may encounter. In turn, the generated performance data can improve the accuracy and level of depth a downstream process relying on test data has in debugging or troubleshooting issues in the features, at least because the characterization of various query execution examples is more robust over other approaches that manually generate test cases or do so based on predicting which inputs may cause errors or performance issues. This troubleshooting can include determining root causes of issues or points of potential optimization in the code base or deployment of a database feature.

Test driver 305 may be configured for modifying some or all aspects of query grammar receipt, control data receipt, data/query generation, query execution, and performance data generation. For example, the test driver 305 may be a software application, source code, compiled instructions, set of parameters or configuration options, API or RPC calls, etc., The test driver 305 can be received, for example, as user input. For example, the testing framework 300 can receive the test driver 305, through an interface, such as a software application, a web page, an API or RPC interface, etc., for causing the DBMS testing framework 300 to perform actions consistent with what is specified by the test driver 305. In general, any action or process described as being performed by the testing framework 300 and/or the DBMS 100 can be modified, removed, or added to by execution of the test driver 305.

The test driver 305 can include sub-routines or instructions for implementing different types of testing on the DBMS 100. The testing can be specific to certain types of queries, certain types of data, or both. The framework 300 can execute the test driver 305 and in doing so, execute these different types of tests.

For example, the test driver 305 may cause the DBMS 100 to omit data preparation altogether, choosing instead to perform any data preparation during query verification. As another example, different parts of how queries are generated and executed may also be modified. For example, the generation and execution of the queries may be modified through overwriting those parts of the testing framework with the test driver 305 and/or through changes to the default operating mode.

The test driver 305 can include a test configuration 310 of parameters or data for modifying some or all of the behavior of the testing framework 300. For example, the test configuration 310 can include flags or other control data for controlling whether query executions are executed with or without certain database features enabled.

The test driver 305 can be configured to receive the test configuration 310. for example as user input. The test configuration 305 can also specify the conditions or environment for testing query execution. For example, the test configuration 310 can specify whether to test the database on primary and replica instances, test the database on different virtual machines, like vCPU 8, vCPU 16, and vCPU 64 machines, as well as for different database schemas or formats, e.g., raw and min/max columnar engine formats for columnar or column-oriented database management systems. A target database system can also be specified in the test configuration 310 for testing on any other database system, which may differ from the DBMS 100, for example, because it is of a different type of DBMS, or a different version of the DBMS 100. In absence of a test configuration 310, the DBMS testing framework 300 may be configured with a default or predetermined test configuration.

The test driver 305 can specify the type or nature of different tests to be performed, for example different correctness tests, performance tests, and/or stress tests, as well as corresponding conditions or parameters for evaluating success or failure in the context of the performed tests in the performance data. The test driver 305 can include user-specified test configurations to customize the test executions such as user specified timeout, different columnar coding scheme, primary or replica tests and so on. The test driver 305 can modify or augment performance data as described herein but maintains the same format or structure that the query verifier 145 is configured to receive as input.

Instance image builder 315 is configured to build user applications as a database instance. In some examples, the DBMS 100 can be implemented as a database instance, for example running on a virtual machine. The database instance can provide the environment for executing a user application, which may rely on or include database features that are being tested. The database instance can include data in the database stored in the storage device 140, as well as software or hardware for managing the included data. Parameters or configuration options for the database instance, e.g., the type of database management software to use, what data to include, and so on, can be indicated in the test configuration 310. In the absence of these configuration options or parameters, the instance image builder 315 is configured to supply default options or prompts for user selection of options or parameters necessary for generating a database instance. In various examples, the database instance can support the inclusion of software for database management systems and user applications implemented in various different programming languages.

Database preparation engine 325 can receive the test driver 305 and modify data preparation for a database ahead of executing the queries. For example, the test driver 305 may specify that data be generated of a specific type or schema, or further specify what data is to be stored in the database. Data preparation engine 325 is configured to generate test data for populating in databases stored in the storage device 140. The preparation engine 325 can generate data according to data types of table columns in a database. Special values, such as NaN, positive and negative infinity, or null can be inserted into the tables.

The test driver 305 can customize different aspects of query generation and execution, such as specified timeout periods, columnar coding schemes for columnar caches, how primary or replicas are tested, how virtual machine or bare-metal computing resources are used during testing, and so on. Further, the test driver 305 can specify the query grammar to be used, how many queries to generate, and which database features to enable or disable during query execution. The DBMS testing framework 300 is configured to receive the test driver 305 and modify the query generation and execution described herein, for example with reference to FIG. 1, in accordance with the test driver 305.

### Example Methods

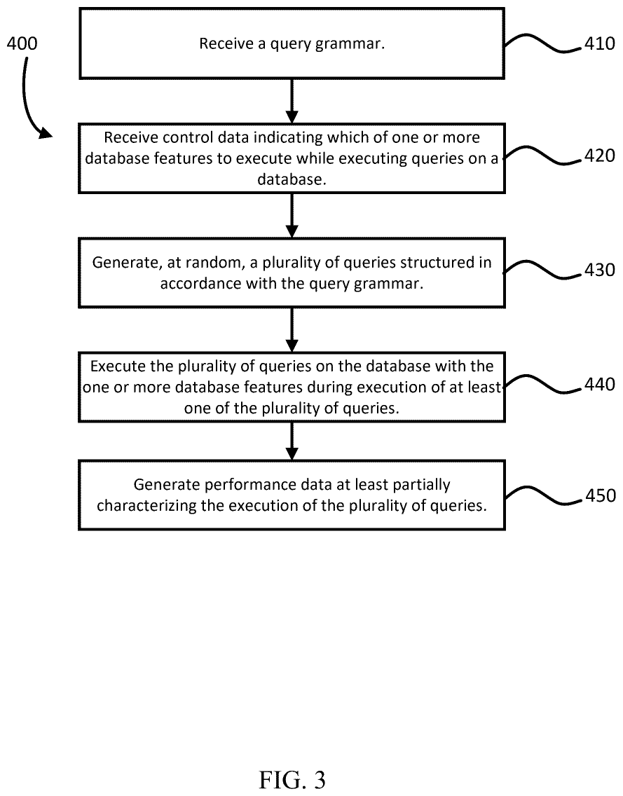

FIG. 3 is a flow diagram of an example process 400 for database feature testing with a database management system, according to aspects of the disclosure. The example process 400 can be performed on a system of one or more processors in one or more locations, such as the DBMS testing framework 300 of FIG. 1.

The system receives a query grammar, according to block 410. The query grammar can be a context-free grammar, for example in Backus-Naur form notation or some other predetermined format. The system may also receive a database schema structured in accordance with the database schema.

The system receives control data indicating which of one or more database features to execute while executing queries on a database, according to block 420. For example, the control data can include a set of control flags, each flag indicating whether a respective database feature from a collection of database features implemented by the system should be enabled for testing purposes.

The system generates, at random, a plurality of queries structured in accordance with the query grammar, according to block 430. The system can also generate the queries in accordance with the database schema, for example by selecting target data in accordance with the database schema. The queries generated can cause the system to perform a variety of different operations when executed on the database, for example by selecting, updating, adding, or removing data.

The system executes the plurality of queries on the database with the one or more database features during the execution of at least one query of the plurality of queries, according to block 440. The system can execute the queries with different database features enabled or disabled at random. The executed queries can include repeats of the same queries but executed, sometimes, with database features indicated in the control data enabled and executed sometimes with database features indicated in the control data disabled. Other database features not indicated in the control data may also be enabled or disabled, for generating more varied performance data.

The system generates performance data at least partially characterizing the execution of the plurality of the queries, according to block 450. Performance data can include data specific to the execution of each query, with or without different database features enabled.

For example, the performance data can include correctness data at least partially characterizing the correctness of output from execution of queries with the one or more database features enabled or disabled, relative to corresponding ground-truth outputs. Ground-truth outputs may be predetermined or determined to be the outputs of queries when database features are disabled.

The performance data may include data at least partially characterizing differences in computational resource cost or usage, e.g., memory bandwidth, memory usage, processing cycles, etc., between executions of queries with the one or more database features enabled and executions of queries with the one or more database features disabled.

The system can identify, based on the performance data, one or more points of failure indicated in the performance data, and identify sources of the system from which the points of failure may have occurred. To identify a point of failure, the system can identify differences in performance data for queries executed with and without certain database features enabled. If the system identifies a difference meeting or in excess of a predetermined threshold, the system can mark the difference as a point of failure in the performance data.

The system can process a list of points of failure identified in the performance data to determine which database features or features were enabled during those points. The features themselves can be identified as sources of failure, and the system can also identify modules or components the system communicates with as part of enabling the identified features.

The system can also generate a snapshot of the database and/or contents of a cache, which can form part of the performance data. The snapshot can be provided to a debugging environment or other system for further analysis, to determine a root cause of failure or other information that can be used to later fix the correctness or performance issues for a database feature. The performance data, the points of failure, and/or the sources of failure can be output to a display of a computing device or provided to another device or system for further processing.

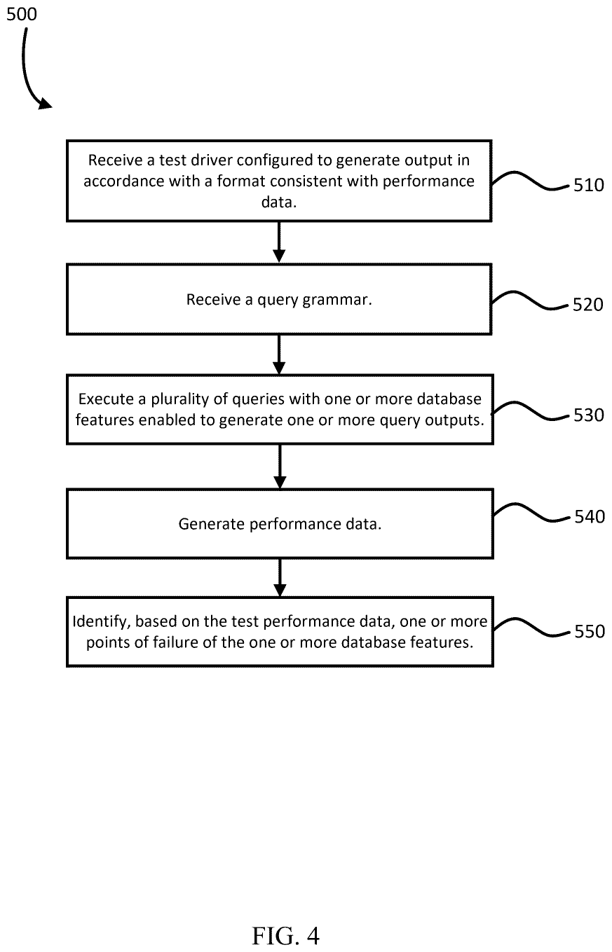

FIG. 4 is a flow diagram of an example process 500 for database feature testing with a database management system testing framework and a test driver, according to aspects of the disclosure. The example process can be performed on a system of one or more processors in one or more locations, such as the DBMS 100 of FIG. 1 implementing the database feature testing framework 300.

The system receives a test driver configured to generate output in accordance with a predetermined format, according to block 510. As described herein with reference to FIG. 1, the test driver can modify or override default behavior of the testing framework 300, in accordance with specific testing requirements or parameters that may be unique for the type of tests being executed, or the type of queries being generated and executed.

The predetermined format can correspond to a format a query verifier is configured to receive for analyzing the performance data and identifying one or more points of failure. The test driver, when executed by the system, can cause the system to perform one or more of receiving the query grammar, generating data for testing, receiving the control data for determining which database features to test, generating queries randomly, verifying the results of executed queries and the performance of the DBMS with respect to predetermined tests, or executing the queries.

The system receives a query grammar, according to block 520. For example, the query grammar can be a grammar as described with reference to FIGS. 1 and 3. The query grammar can be a context-free grammar, for example in Backus-Naur form notation or some other predetermined format.

The system executes a plurality of queries with one or more database features enabled to generate one or more query outputs, according to block 530. The results of the query outputs can be provided in addition to other metrics or information to form the performance data. Query results may fail or have different values depending on whether the same query was executed with different database features enabled or disabled.

The system generates performance data, according to block 540. The performance data can include results from executing the queries, as well as other characteristics for identifying points of failure in the query executions relative to different types of tests that may be performed by the system.

The system identifies, based on the performance data, one or more points of failure of the one or more database features, according to block 560. As described herein with reference to FIG. 1, the system includes a query verifier configured to compare performance results for queries with different combinations of database features enabled and disabled. The verifier can compile a list of potential sources of failure based on instances of test results in which, for example, a query execution failed, inconsistent results were generated, or a query execution was not performed within predetermined performance thresholds for latency, memory usage, processing utilization, etc.

Implementations of the present technology can each include, but are not limited to, the following. The features may be alone or in combination with one or more other features described herein. In some examples, the following features are included in combination:
(1) A method for testing features of a database management system, including: receiving, by one or more processors, a query grammar; receiving, by the one or more processors, control data indicating which of one or more database features to enable, the one or more processors configured to perform one or more the database features; generating at random, by the one or more processors, a plurality of queries in accordance with the query grammar; executing, by the one or more processors, the plurality of queries on a database with the one or more database features enabled based on the control data for at least one query of the plurality of queries; generating, by the one or more processors, performance data based on performance of the execution of the plurality of queries; and identifying, by the one or more processors and based on the performance data, one or more points of failure in executing queries with at least one database feature enabled.
(2) The method of (1), further including: receiving, by the one or more processors, a test driver configured to perform one or more of: receiving the query grammar, receiving the control data, generating the plurality of queries, or executing the plurality of queries, wherein the test driver is further configured to generate the performance data in accordance with a predetermined format; and executing, by the one or more processors, the test driver, as part of one or more of receiving the query grammar, receiving the control data, generating the plurality of queries, or executing the plurality of queries.
(3) The method of either one of (1) or (2), wherein executing the plurality of queries includes executing the plurality of queries with the one or more database features enabled or disabled at random.
(4) The method of any one of (1) through (3), wherein a point of failure includes one or more of: an incorrect response to execution of a query, or execution of a query not meeting a predetermined performance threshold.
(5) The method of any one of (1) through (4), further including: executing, by the one or more processors, one or more modules corresponding to the one or more database features; and identifying, by the one or more processors, based on the one or more points of failure, the at least one database feature enabled when the one or more points of failures occurred.
(6) The method any one of (1) through (5), further including generating a snapshot of the database after identifying the one or more points of failure.
(7) The method of any one of (1) through (6), wherein identifying the one or more points of failure includes: identifying a difference between: first performance data at least partially characterizing execution of one or more of the plurality of queries with a first database feature of the one or more database features enabled, and second performance data at least partially characterizing execution of one or more of the plurality of queries with the first database feature disabled; determining that the difference between the first and the second performance data meets or exceeds a predetermined difference threshold; and in response to the determining, identifying the difference between the first and the second performance data as a point of failure for the first database feature.
(8) The method of any one of (1) through (7), wherein the performance data includes one or more of: correctness data at least partially characterizing the correctness of output from execution of queries with the one or more database features enabled or disabled, relative to corresponding ground-truth outputs, or performance data at least partially characterizing differences in computational resource cost or usage between executions of queries with the one or more database features enabled and executions of queries with the one or more database features disabled.
(9) The method of (8), wherein ground-truth outputs include outputs from executing queries with the one or more database features disabled.
(10) The method of any one of (1) through (9), further including: receiving, by the one or more processors, a database schema, the database structured in accordance with the database schema; and generating the plurality of queries includes generating the plurality of queries with target data selected in accordance with the database schema.
(11) The method of any one of (1) through (10), wherein the query grammar is a context-free grammar.
(12) The method of any one of (1) through (11), further including outputting, by the one or more processors, the performance data to a display of a computing device.
(13) A database management system including: one or more memory devices storing a database; and one or more processors configured to operations of the method of any one of (1) through (12).
(14) A method including: receiving, by one or more processors, a query grammar; receiving a test driver configured to generate output in accordance with a format consistent with performance data; executing, by the one or more processors, the test driver with one or more database features enabled to perform one or more of: generating a plurality of queries or executing the plurality of queries; executing, by the one or more processors, the plurality of queries with one or more database features enabled to generate one or more query outputs; generating, by the one or more processors, the performance data; and identifying, based on the performance data, one or more points of failure of the one or more database features.
(15) The method of (14), further including the method of any one of (1) through (13).
(16) One or more computer-readable storage media storing instructions that are operable, when executed by one or more processors, to cause the one or more processors to perform operations as in the method of any one of (1) through (12).
(17) The computer-readable storage media of (14), wherein the computer-readable storage media is non-transitory.

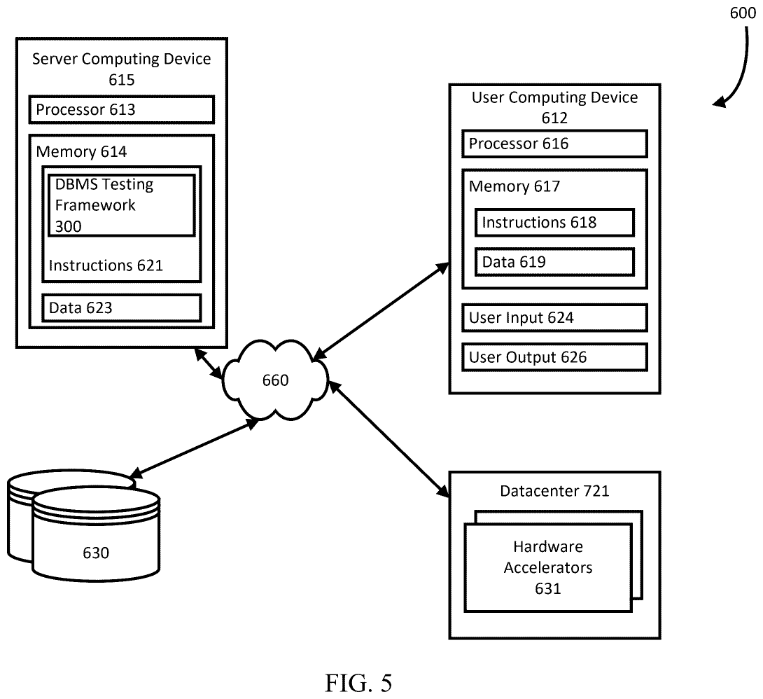

FIG. 5 is a block diagram of an example computing environment 600 for implementing a DBMS testing framework, such as the DBMS testing framework 300 of FIG. 1. The DBMS testing framework 300 can be implemented on one or more devices having one or more processors in one or more locations, such as in server computing device 615. User computing device 612 and the server computing device 615 can be communicatively coupled to one or more storage devices 630 over a network 660. The storage device(s) 630 can be a combination of volatile and non-volatile memory and can be at the same or different physical locations than the computing devices 612, 615. For example, the storage device(s) 630 can include any type of non-transitory computer readable medium capable of storing information, such as a hard-drive, solid state drive, tape drive, optical storage, memory card, ROM, RAM, DVD, CD-ROM, write-capable, and read-only memories. In some examples, the testing framework 300 and the DBMS 100 are part of a larger, composite system. In some examples, the DBMS 100 and testing framework 300 may at least partially overlap in function or implementation, or be implemented on separate devices.

Aspects of the disclosure can be implemented in a computing system that includes a back-end component, e.g., as a data server, a middleware component, e.g., an application server, or a front-end component, e.g., user computing device 612 having a user interface, a web browser, or an app, or any combination thereof. The components of the system can be interconnected by any form or medium of digital data communication, such as a communication network. Examples of communication networks include a local area network (LAN) and a wide area network (WAN), e.g., the Internet. The datacenter 721 can also be in communication with the user computing device 612 and the server computing device 615 and include one or more hardware accelerators 631.

The computing system can include clients, e.g., user computing device 612 and servers, e.g., server computing device 615. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

The server computing device 615 can include one or more processors 613 and memory 614. The memory 614 can store information accessible by the processor(s) 613, including instructions 621 that can be executed by the processor(s) 613. The memory 614 can also include data 623 that can be retrieved, manipulated, or stored by the processor(s) 613. The memory 614 can be a type of non-transitory computer readable medium capable of storing information accessible by the processor(s) 613, such as volatile and non-volatile memory. The processor(s) 613 can include one or more central processing units (CPUs), graphic processing units (GPUs), field-programmable gate arrays (FPGAs), and/or application-specific integrated circuits (ASICs), such as tensor processing units (TPUs).

The instructions 621 can include one or more instructions that when executed by the processor(s) 613, causes the one or more processors to perform actions defined by the instructions. The instructions 621 can be stored in object code format for direct processing by the processor(s) 613, or in other formats including interpretable scripts or collections of independent source code modules that are interpreted on demand or compiled in advance. The instructions 621 can include instructions for implementing the DBMS testing framework 300 consistent with aspects of this disclosure. The DBMS testing framework 300 can be executed using the processor(s) 613, and/or using other processors remotely located from the server computing device 615.

The data 623 can be retrieved, stored, or modified by the processor(s) 613 in accordance with the instructions 621. The data 623 can be stored in computer registers, in a relational or non-relational database as a table having a plurality of different fields and records, or as JSON, YAML, proto, or XML documents. The data 623 can also be formatted in a computer-readable format such as, but not limited to, binary values, ASCII, or Unicode. Moreover, the data 623 can include information sufficient to identify relevant information, such as numbers, descriptive text, proprietary codes, pointers, references to data stored in other memories, including other network locations, or information that is used by a function to calculate relevant data.

The user computing device 612 can also be configured similarly to the server computing device 615, with one or more processors 616, memory 617, instructions 618, and data 619. For example, the user computing device 612 can be a mobile device, a laptop, a desktop computer, a game console, etc. The user computing device 612 can also include a user output 626, and a user input 624. The user input 624 can include any appropriate mechanism or technique for receiving input from a user, including acoustic input; visual input; tactile input, including touch motion or gestures, or kinetic motion or gestures or orientation motion or gestures; auditory input, speech input, etc., Example devices for user input 624 can include a keyboard, mouse or other point device, mechanical actuators, soft actuators, touchscreens, microphones, and sensors.

The server computing device 615 can be configured to transmit data to the user computing device 612, and the user computing device 612 can be configured to display at least a portion of the received data on a display implemented as part of the user output 626. The user output 626 can also be used for displaying an interface between the user computing device 612 and the server computing device 615. The user output 626 can alternatively or additionally include one or more speakers, transducers or other audio outputs, a haptic interface or other tactile feedback that provides non-visual and non-audible information to the platform user of the user computing device 612.

Although FIG. 5 illustrates the processors 613, 616 and the memories 614, 617 as being within the computing devices 615, 612, components described in this specification, including the processors 613, 616 and the memories 614, 617 can include multiple processors and memories that can operate in different physical locations and not within the same computing device. For example, some of the instructions 621, 618 and the data 623, 619 can be stored on a removable SD card and others within a read-only computer chip. Some or all of the instructions and data can be stored in a location physically remote from, yet still accessible by, the processors 613, 616. Similarly, the processors 613, 616 can include a collection of processors that can perform concurrent and/or sequential operation. The computing devices 615, 612 can each include one or more internal clocks providing timing information, which can be used for time measurement for operations and programs run by the computing devices 615, 612.

The server computing device 615 can be configured to receive requests to process data from the user computing device 612. For example, the environment 600 can be part of a computing platform configured to provide a variety of services to users, through various user interfaces and/or APIs exposing the platform services. One or more services can be a machine learning framework or a set of tools for training or executing generative models or other machine learning models according to a specified task and training data.

The devices 612, 615 can be capable of direct and indirect communication over the network 660. The devices 615, 612 can set up listening sockets that may accept an initiating connection for sending and receiving information. The network 660 itself can include various configurations and protocols including the Internet, World Wide Web, intranets, virtual private networks, wide area networks, local networks, and private networks using communication protocols proprietary to one or more companies. The network 660 can support a variety of short- and long-range connections. The short- and long-range connections may be made over different bandwidths, such as 2.402 GHz to 2.480 GHz (commonly associated with the Bluetooth® standard), 2.4 GHz and 5 GHZ (commonly associated with the Wi-Fi® communication protocol); or with a variety of communication standards, such as the LTE® standard for wireless broadband communication. The network 660, in addition or alternatively, can also support wired connections between the devices 612, 615, including over various types of Ethernet connection.

Although a single server computing device 615, user computing device 612, and datacenter 621 are shown in FIG. 5, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more engines or modules of computer program instructions encoded on one or more tangible non-transitory computer storage media for execution by, or to control the operation of, one or more data processing apparatus.

A computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus. A computer program may, but need not, correspond to a file in a file system. A computer program can be stored in a portion of a file that holds other programs or data, e.g., one or more scripts, in a single file, or in multiple coordinated files, e.g., files that store one or more engines, modules, sub-programs, or portions of code.

The term “configured” is used herein in connection with systems and computer program components. For a system of one or more computers to be configured to perform particular operations or actions means that the system has installed software, firmware, hardware, or a combination thereof that cause the system to perform the operations or actions. For one or more computer programs to be configured to perform operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC), such as a Tensor Processing Unit (TPU). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “engine” can refer to a software-based system, subsystem, or process that is programmed to perform one or more specific functions. The engine can be implemented as one or more software modules or components or can be installed on one or more computers in one or more locations. A particular engine can have one or more processors or computing devices dedicated thereto, or multiple engines can be installed and running on the same processor or computing device. In some examples, an engine can be implemented as a specially configured circuit, while in other examples, an engine can be implemented in a combination of software and hardware.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers. While operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all examples, and it should be understood that the described program components and systems can be integrated together in one or more software or hardware-based devices or computer-readable media.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, desktop computer, a personal digital assistant (PDA), a mobile audio or video player, a game console, a tablet, a virtual-reality (VR) or augmented-reality (AR) device, a Global Positioning System (GPS), or a portable storage device, e.g., a universal serial bus (USB) flash drive, as examples. Examples of the computer or special purpose logic circuitry can include the user computing device 612, the server computing device 615, or the hardware accelerators 631.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible examples. Further, the same reference numbers in different drawings can identify the same or similar elements.

1. A method for testing features of a database management system, comprising:
receiving, by one or more processors, a query grammar;
receiving, by the one or more processors, control data indicating one or more database features to enable while executing queries on a database;
generating at random, by the one or more processors, a plurality of queries structured in accordance with the query grammar;
executing, by the one or more processors, the plurality of queries on the database with the one or more database features enabled during execution of at least one query of the plurality of queries; and
generating, by the one or more processors, performance data at least partially characterizing the execution of the plurality of queries.

2. The method of claim 1, further comprising:
identifying, by the one or more processors and based on the performance data, one or more points of failure indicated in the performance data, and
identifying, by the one or more processors and based on the one or more points of failure, at least one module of one or more modules executing the one or more database features as a source of failure.

3. The method of claim 2, further comprising generating, by the one or more processors, a snapshot of the database after identifying the one or more points of failure.

4. The method of claim 2, wherein identifying the one or more points of failure comprises:
identifying, by the one or more processors, a difference between:
first performance data at least partially characterizing execution of one or more of the plurality of queries with a first database feature of the one or more database features enabled, and
second performance data at least partially characterizing execution of one or more of the plurality of queries with the first database feature disabled;
determining, by the one or more processors, that the difference between the first and the second performance data meets or exceeds a predetermined difference threshold; and
in response to the determining, identifying, by the one or more processors, the difference between the first and the second performance data as a point of failure for the first database feature.

5. The method of claim 1, wherein executing the plurality of queries comprises executing, by the one or more processors, queries with the one or more database features enabled or disabled at random.

6. The method of claim 1, wherein the performance data comprises one or more of:
correctness data at least partially characterizing the correctness of output from execution of queries with the one or more database features enabled or disabled, relative to corresponding ground-truth outputs, or
performance data at least partially characterizing differences in computational resource cost or usage between executions of queries with the one or more database features enabled and executions of queries with the one or more database features disabled.

7. The method of claim 6, wherein ground-truth outputs comprise outputs from executing queries with the one or more database features disabled.

8. The method of claim 1, further comprising:
receiving, by the one or more processors, a database schema, the database being structured in accordance with the database schema; and
when generating the plurality of queries, the plurality of queries are generated with target data selected in accordance with the database schema.

9. The method of claim 1, wherein generating the performance data further comprises:
receiving, by the one or more processors, a test driver configured to generate output in accordance with a format in accordance with the performance data;
generating, by the one or more processors, query outputs; and
generating, by the one or more processors, the performance data at least partially based on the query outputs, and in accordance with the test driver.

10. The method of claim 9, wherein:
the test driver is configured to perform one or more of:
receiving the query grammar,
receiving the control data,
generating the plurality of queries, or
executing the plurality of queries, and
identifying, by the one or more processors, based on the performance data, one or more points of failure of the one or more database features.

11. The method of claim 1, wherein the query grammar is a context-free grammar.

12. The method of claim 1, further comprising outputting, by the one or more processors, the performance data to a display of a computing device.

13. A system comprising:
one or more memory devices storing a database; and
one or more processors configured to:
receive a query grammar;
receive control data indicating one or more database features to enable while executing queries on a database;
generate a plurality of queries structured in accordance with the query grammar;
execute the plurality of queries on the database with the one or more database features enabled during execution of at least one query of the plurality of queries; and
generate performance data at least partially characterizing the execution of the plurality of queries.

14. The system of claim 13, wherein:
the one or more processors are configured to communicate with one or more modules when executing the one or more database features; and
the one or more processors are further configured to:
identify, based on the performance data, one or more points of failure indicated in the performance data, and
identify, based on the one or more points of failure, at least one module of the one or more modules as a source of failure.

15. The system of claim 14, wherein the one or more processors are further configured to generate a snapshot of the database after identifying the one or more points of failure.

16. The system of claim 14, wherein in identifying the one or more points of failure, the one or more processors are further configured to:
identify a difference between:
first performance data at least partially characterizing execution of one or more of the plurality of queries with a first database feature of the one or more database features enabled, and
second performance data at least partially characterizing execution of one or more of the plurality of queries with the first database feature disabled;
determine that the difference between the first and the second performance data meets or exceeds a predetermined difference threshold; and
in response to the determination, identify the difference between the first and the second performance data as a point of failure for the first database feature.

17. The system of claim 13, wherein in executing the plurality of queries, the one or more processors are configured to execute queries with the one or more database features enabled or disabled at random.

18. The system of claim 12, wherein the performance data comprises one or more of:
correctness data at least partially characterizing the correctness of output from execution of queries with the one or more database features enabled or disabled, relative to corresponding ground-truth outputs, or
performance data at least partially characterizing differences in computational resource cost or usage between executions of queries with the one or more database features enabled and executions of queries with the one or more database features disabled.

19. The system of claim 12, wherein in generating the performance data, the one or more processors are further configured to:
receive a test driver configured to generate output in accordance with a format in accordance with the performance data;
generate query outputs; and
generate the performance data at least partially based on the query outputs and in accordance with the test driver.

20. One or more non-transitory computer-readable storage media encoded with instructions that, when executed by one or more processors, cause the one or more processors to perform operations comprising:
receiving a query grammar;
receiving control data indicating one or more database features to enable while executing queries on a database;
generating, at random, a plurality of queries structured in accordance with the query grammar;
executing the plurality of queries on the database with the one or more database features enabled during execution of at least one query of the plurality of queries; and
generating performance data at least partially characterizing the execution of the plurality of queries.
